(19) United States
(12) Patent Application Publication
(10) Pub. No.: US 2010/0259545 A1
(43) Pub. Date: Oct. 14, 2010

(54) SYSTEM AND METHOD FOR SIMPLIFYING THE CREATION AND STORAGE OF COMPLEX ANIMATION OBJECTS AND MOVIES

(76) Inventor: Shimon Elnatan, Petach Tikva (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 12/491,303

(22) Filed: Jun. 25, 2009

(30) Foreign Application Priority Data
Jun. 26, 2008 (IL) 192478

(51) Int. Cl. G06T 15/70

(52) U.S. Cl. 345/473

(57) ABSTRACT

An animation generation system for online recording and editing of elaborated animation objects and movies, that comprises a plurality of elaborated animated objects with hinges for controlling the object's limb movement; a collection of associated actions with parameters which can be programmed by authorized animation developers, who may be registered web site members that communicate through messages which comprise the created animation movies and objects using the Internet infrastructure; a collection of actions of associated generic features and a collection of associated actions complex moves comprising ready made small actions; A database of elaborated animated objects and movies containing accumulated collection of animation movies and objects created; A user interface module for presenting objects' features, for allowing a user to choose animation objects or related actions, for inserting actions by dragging and dropping, for playing an edited scene and for recognizing the action pattern of a developer's input and identifying the animation object and suggesting a variety of possible actions.

### FIELD OF THE INVENTION

The present invention relates to the field of animation production. Specifically, this invention relates to a method and system for simplifying the creation and storage of complex animation objects and movies for use in connection with an Internet web page.

### BACKGROUND OF THE INVENTION

As animation becomes more readily available, simultaneously the complexity of creating animation has also increased. As such, animations are usually created by highly trained animators who use animation principles to create motion that is complex, so that traditional animation is a time consuming and expensive industry.

Much research effort has been devoted to the reduction of the work involved in different cartoon production phases, such as automatic in-betweening, automatic coloring, automatic linking as well as management aspects including uniformity of processing, cross-referencing of different stages, database techniques for frames and sequences, the ability to capture and reuse movements and the separation of visual appearance from movement and sound.

“Reuse of clips in cartoon animation based on language instructions” (W E I Bao-gang, Z H U Wen-hao and Y U Jin-hui, 123 Journal of Zhejiang University SCIENCE A, pp. 123-129, Oct. 15, 2005) discloses an automatic reuse of clips in cartoon animation. A system called RUCLI retrieves old cartoon clips, stored in a database, based on parsed high-level language instructions, in order to avoid manually retrieving of drawings from a database. Nevertheless, the disclosed technique suffers from some drawbacks when dealing with complex animation. More specifically, the disclosed technique was designated for animation professionals solely for reusing old cartoon frames while creating new animation clips.

U.S. Pat. No. 6,636,219 discloses a system and method for generating character animation for use in an Internet environment. The disclosed system comprises an animation preparation application which assigns a dialog to a pre-existing character templates and which automatically generates lips movements and behaviors which are synchronized with audio content and which may be implemented by embedding such animations in a web page. Nevertheless, the disclosed method fails to provide intuitive user interface for online recording and editing of elaborated animation objects and movies, for full content reuse. Thus, U.S. Pat. No. 6,636,219 fails to fulfill the need for significant specialized skills from the user in order to prepare a dynamic animation.

US 2005/0187806 disclose a global animation system which relates to assigning and managing resources for use in animation projects. Some software packages established the standard for component of animation including wire frames, three dimensional (3D) visual objects, object rigging (describing dynamic behavior) and file formats. The main object of the disclosed system is to manage price/production value tradeoffs while coordinating and controlling global production resources. Nevertheless, US 2005/0187806 fails to provide user friendly editing means for online scene editing which avoid offline editing and re-compilation of the animation movie to see the results.

It is therefore an object of the invention to provide an animation wizard provided with ever growing pool of ready made complex animation objects with inherited and changeable features and actions attributes which can be activated or reprogrammed, simultaneously and online, by the user.

It is another object of the present invention to provide ever growing pool of complex animation objects to be used or modified by the animation wizard users in order to create their own movie.

It is yet another object of the invention to provide the animation wizard users with the ability to store their newly created animation objects to be commonly used by all of the animation wizard users.

It is a further object of the invention to provide the animation wizard users with the ability to edit an animation scene while playing it, thus, avoiding offline editing and re-compilation of an animation movie to see the results.

It is yet another object of the invention to provide the animation wizard users with an intuitive, yet advanced animation wizard user interface to schedule, simultaneously and online, plurality of elaborated animation objects.

It is still another object of the invention to provide an advanced communication/commercial/advertisement animation wizard mean.

### SUMMARY OF THE INVENTION

In one aspect, the present invention provides an animation generation system for online recording and editing of elaborated animation objects and movies, that comprises:

a plurality of elaborated animated objects, each of which including:

a.1) hinges for controlling the object's limb movement;

a.2) an accumulated collection of associated actions having parameters which can be programmed by a group of authorized animation developers, who may be registered web site members that communicate through messages which comprise the created animation movies and objects using the Internet infrastructure;

a.3) an accumulated collection of associated actions of associated generic features;

a.4) an accumulated collection of associated actions complex moves comprising ready made small actions;

a database of elaborated animated objects and movies containing accumulated collection of animation movies and objects created by the group;

a user interface module for:

c.1) presenting objects' features;

c.2) allowing a user to choose animation objects, animation scenes backgrounds or related actions;

c.3) inserting actions with their programmed time table, by dragging and dropping;

c.4) playing an edited scene; and

c.5) recognizing the action pattern of a developer's input and identifying the animation object and suggesting a variety of possible actions.

The user interface module may comprise:

c.1) an Objects tray, a Scene Background tray and an Actions Applied tray being capable of prompting a user to choose one of the animation objects, animation scenes backgrounds or related actions, applied for composing his own animation movie;

c.2) a side table on which every object features will be presented upon its selection, for prompting the developers to design the object generic features;

c.3) a Control Time Table to which all actions, selected from the Actions Applied tray or from a right click menu, can be inserted by dragging and dropping, such that the timing of all inserted actions will start on the time table point of insertion and will be programmed to last according to the length of arrows extended by the developers using an editing window;

c.4) a Play Clip button for enabling the developers to start an online editing mode for editing the scene while playing it on a related portion of the user interface, without needing re-compilation;

c.5) a User Action Pattern recognition application, linked to the database and with the user interface unit, for receiving the developer's input and recognizing the action pattern;

c.6) an Object processor which receives the recognized action pattern, identifies the animation object and suggests a variety of possible actions through the User interface unit.

The user's action sequence and uses the object's inherited pre-programmed properties and action parameters may be monitored, for automatically suggesting the user a variety of relevant pre-defined properties and action parameters. The animation object may further comprise associated objects and object actions. A Double click on any action appearing on the Control Time Table may open an action edit window for editing the action.

The newly created animation movies and objects may be based on the existing animation movies and objects and may further comprise a commercial logo of a company. The authorized group of animation developers may set the life span of the newly created animation movies and objects.

The Control Time Table may provide a single synchronized set of axes which incorporates different objects into the clip design environment.

Clicking on the newly created animation movies and objects, after stopping or during clip playing, may enable the group of animation users to stop the animation movie and to be linked to a designated Web site, linked with the specific scene, specific screen area and specific timing of animation movies and objects.

In another aspect, the present invention provides an animation generation method for online recording and editing of elaborated animation objects and movies, comprising:
storing a database of elaborated animated objects and movies containing ever growing data representing collection of animation movies and objects created by a group of authorized animation developers,

wherein the elaborated animated objects comprise:

hinges that enable the animation developers to control the objects limb moving,

ever growing data representing a collection of associated actions having parameters which can be programmed by the authorized animation developers, a collection of associated complex moves comprising ready made small actions or a collection of associated generic features;
picking an inherited animation object from the object tray, wherein every inherited animation object has inherited features and action attributes;
picking, from Scene Backgrounds tray and Action Applied tray, the inherited animation objects respective inherited features and action attributes;
analyzing the selected objects, along with their associated objects and its associated capabilities;
detecting the action sequence made by the authorized animation developers;
suggesting a set possible actions/parameters, to the authorized group of animation developers, according to the previously detected action sequence and the respective animation objects they were made on;
allowing the authorized animation developers to selects their preferred parameters;
providing the ability of editing the scene during “play” mode which avoid the need of offline editing and re-compilation of the movie to see the results;
scheduling all action related parameters by inserting them into the movie timeline ruler; wherein all action related parameters will start according to the timeline ruler point of insertion and will last in accordance to the schedule defined by the timeline ruler; and
populating all action related parameters into a movie design files including a movie timeline ruler.

The animation objects or movies may include web banners, sometimes compiled as Small Web Format (SWF) files.

All the above and other characteristics and advantages of the invention will be further understood through the following illustrative and non-limitative description of preferred embodiments thereof.

### BRIEF DESCRIPTION OF THE DRAWINGS

In the drawings:

FIG. 1 is a simplified flow diagram showing the method of the invention's animation wizard for simplified creation and storage of complex animation objects and movies;

FIG. 2 is a simplified functional block diagram showing the system of the invention's animation wizard for simplified creation and storage of complex animation objects and movies according to a preferred embodiment of the present invention;

FIG. 3 is a simplified functional block diagram showing the system of the invention's animation wizard for simplified creation and storage of complex animation objects and movies according to another preferred embodiment of the present invention; and

FIG. 4 is an illustration of an exemplary dialog box of the invention's animation wizard for simplified creation and storage of complex animation objects and movies according to a preferred embodiment of the present invention.

### DETAILED DESCRIPTION OF PREFERRED EMBODIMENTS

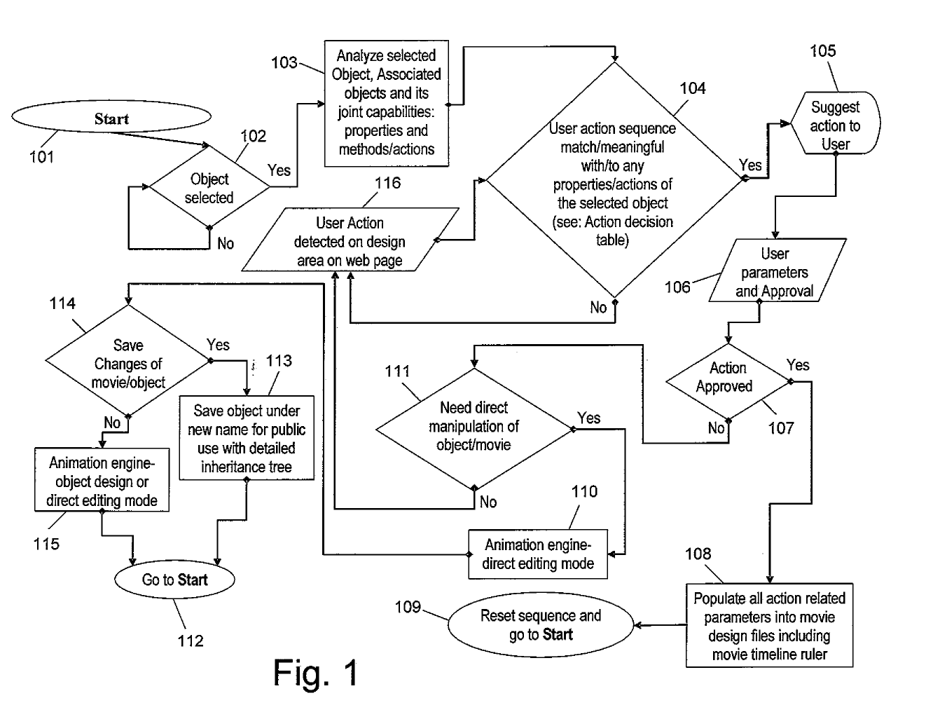

FIG. 1 illustrates a simplified flow diagram showing a method for simplified creation and storage of complex animation objects and movies, according to a preferred embodiment of the present invention. The user initiates the animation wizard in block 101 by picking an inherited animation object from the object tray. Every inherited animation object, picked from the object tray, has inherited features and action attributes additionally picked from Scene Backgrounds tray and Action Applied tray respectively. Decision block 102 determines whether the user has already picked his desired objects/attributes/actions. If so, in block 103 the selected objects (e.g., man, women, boy, girl) are analyzed along with their associated objects (e.g. shirt, pants, gun, guitar) and its associated capabilities such as properties (e.g. style, color, shape, location) and actions (e.g. shoot, play). Decision block 104 determines whether the action sequence made by the user (e.g., an object is dragged and dropped, double-clicking on the mouth, select face and drag mouth tip down) correspond to the properties/actions of the selected objects. If not, user's actions are detected on a designated area on the web page by block 116, providing the ability of editing the scene during “play” mode which avoids the need of offline editing and re-compilation of the movie to see the results. If yes, an action/parameter is suggested (e.g. speak, shout, dance, stretch, limb), by block 105, to the user. The user selects his preferred parameters, by block 106. Decision block 107 determines whether the chosen parameters are approved. If not, the NO branch leads to decision block 111 in which a determination is made whether there is a need for direct manipulation of the objects. If yes, block 108 populate all action related parameters into a movie design file including a movie timeline ruler. All action related parameters are scheduled by inserting them into the movie timeline ruler. All action related parameters will start according to the timeline ruler point of insertion and will last in accordance to the schedule defined by the timeline ruler. After populating the action related parameters into the files the sequence will be reset, by block 109, and the animation wizard returns to the starting block 101. If the NO branch is taken in decision block 111, user's actions are detected on a designated area on the web page by block 116. If the YES branch is taken, the user is forwarded to block 110 for direct editing mode, after which decision block 114 determines whether to save the newly created changes of the movie/objects. If the YES branch is taken, the objects are saved under new name with detailed inheritance tree for public use, by block 113 after which the method return to the start block 101. If the NO branch is taken in decision block 114, objects are forwarded to the animation engine in block 115 for object design or for direct editing mode after which the method return to the start block 101.

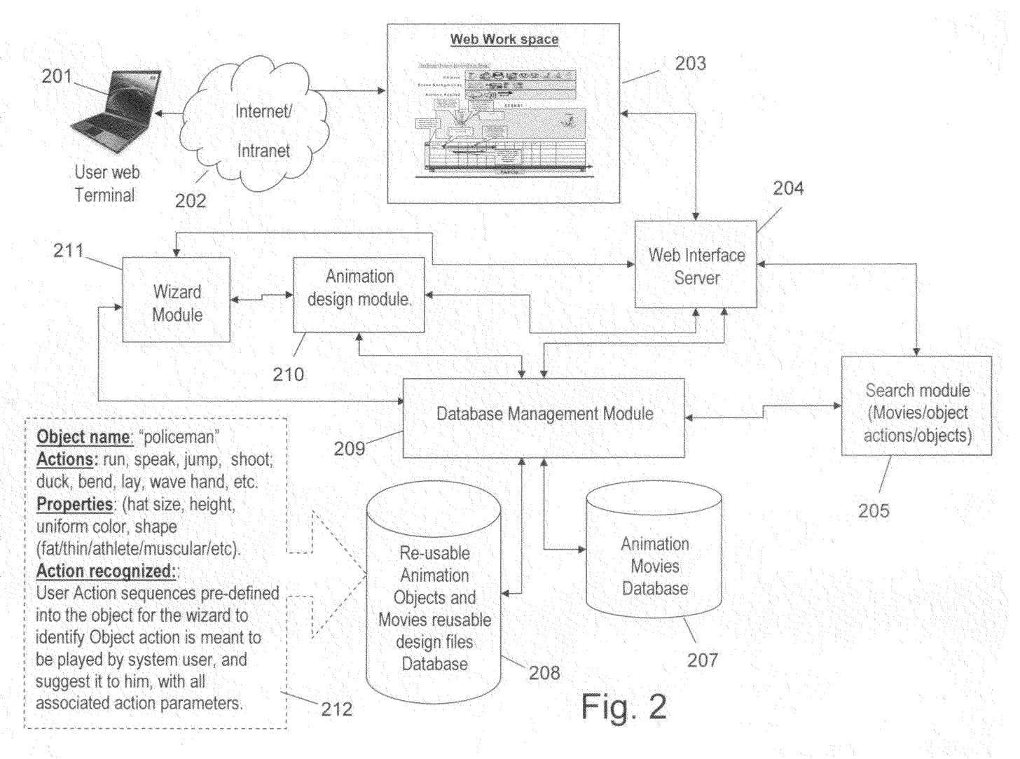

FIG. 2 illustrates a simplified flow diagram showing the animation wizard for simplifying the creation and storage of complex animation objects and movies, according to a preferred embodiment of the present invention. The Internet/Intranet 202 network interconnects the user web terminal 201, which comprises client software, with the Web Workspace 203 website, which comprises server software, providing the user's GUI for interacting with the animation wizard, which is executed on the Web Interface Server 204. The Web Interface Server 204 comprises the Wizard Module software 211 and the Search module software 205, for searching and retrieving existing Movies/objects/object's actions to be reused by the Web Workspace 203 website members. Both the Wizard Module software 211 and the Search module software 205 communicate with Database Management Module 209 which manages both the reuse of created animation Movies/objects/object's actions, in the Re-usable Animation Objects and Movies reusable design files Database 208, and the storage of animation movies created by the Web Workspace 203 website members, in the Animation Movies Database 207. Every pre-programmed animation object will have its inherited pre-programmed properties and action parameters as illustrated by block 212. The abovementioned pre-programmed object properties and action parameters comprise the object name as reference to the pre-programmed object structure (e.g., a policeman, nurse, fireman). Every pre-defined object comprises pre-defined actions (e.g. run, speak, jump), pre-defined properties (e.g. hat size, height, uniform color). The disclosed animation wizard monitors the user's action sequence and uses the object's inherited pre-programmed properties and action parameters to automatically suggest the user a variety of relevant pre-defined properties and action parameters, thus, easing the process of animation creation in general and more specifically semi-automating the process of retrieving pre-defined animation properties.

According to another preferred embodiment, the animation object (e.g. man, women, child) further comprises its associated objects (e.g. guitar, gun, binoculars) and the associated object actions (e.g. shooting the gun, playing the guitar).

According to another preferred embodiment, the animation object may further comprise its linked objects (e.g. hair, eyes, shirt), its linked objects properties (e.g. style, color, shape, location) and its linked objects actions (e.g. blow, rest, jump).

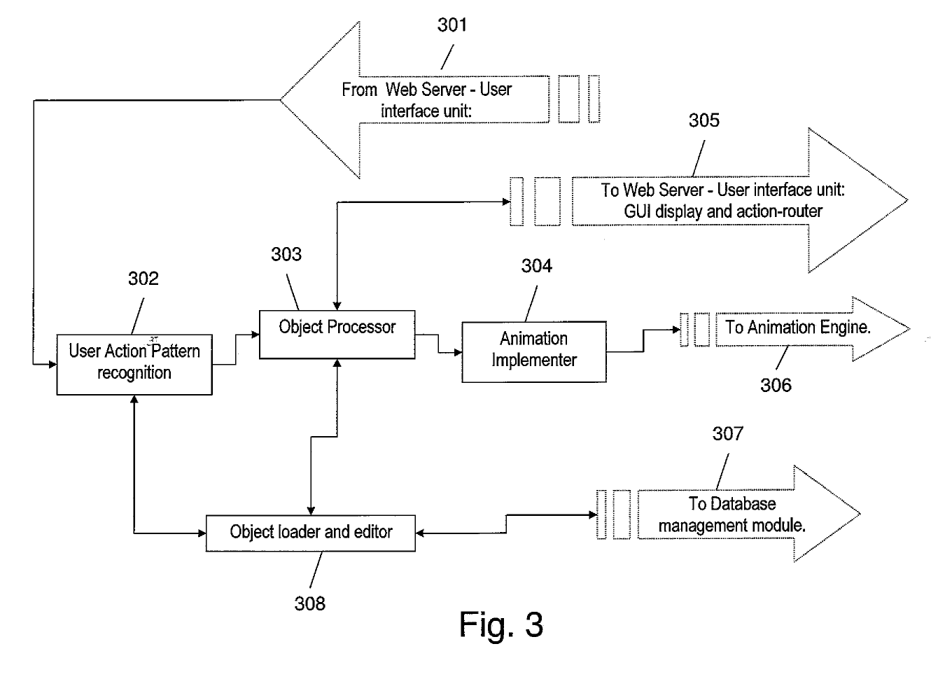

FIG. 3 illustrates a simplified flow diagram showing the animation wizard for simplifying the creation and storage of complex animation objects and movies, according to another preferred embodiment of the present invention. User Action Pattern recognition 302 receives the user input from the User interface unit 301 executed on a web server. The User Action Pattern recognition 302, in accordance with the Object loader and editor 308, analyses the received input, according to the received input from User Action Pattern recognition 302, and transfer the recognized action pattern to the Object processor 303. The Object processor 303, in accordance with the Object loader and editor 308, identify the animation object the user action was made on, in order to suggest a variety of possible actions to the user through the User interface unit 305 (e.g. the animation object is a human and the user action is double click on the mouth-suggested action to the user-speak/shout/yawn/stick-tongue/chew, the animation object is a 4 legged animal and the user action is dragging and dropping the animal-suggested action to the user-jump/run/fly). The Object loader and editor 308 uses the Database management module 307 in order to retrieve existing animation objects along with their associated objects and their encapsulated actions. Database management module 307 is being further used by the Object loader and editor 308 to store newly created animation object along with their associated objects and their encapsulated actions for future use. The user's received decision is forwarded to Animation Engine 306 by Animation Implementer 304.

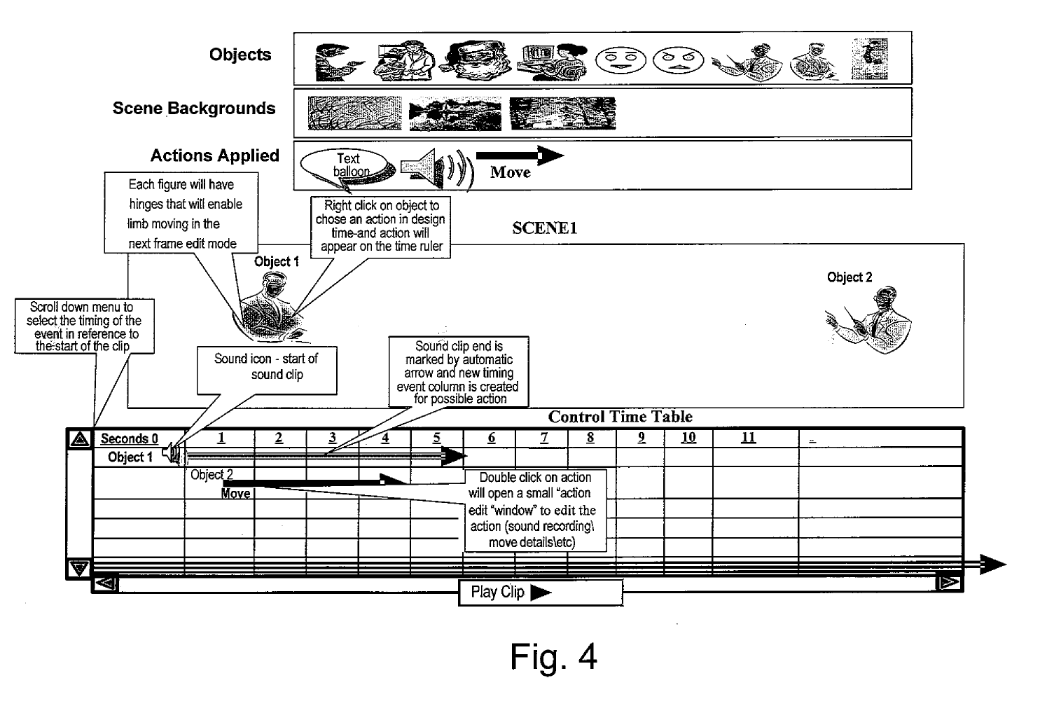

FIG. 4 illustrates an exemplary dialog box of the animation wizard for simplifying the creation and storage of complex animation objects and movies, according to a preferred embodiment of the present invention. The Objects tray, the Scene Background tray and the Actions Applied tray prompt the animation wizard's users to choose either one of the existing animation objects, animation scenes backgrounds or related actions applied in order to compose their own animation movie. Every object from the Objects tray will have features and action selected from the Actions Applied tray or from a right click menu. The abovementioned Objects tray and Actions Applied tray comprises an ever growing complex animation objects as well as their associated actions. Every object features will be presented on a side table, upon this object selection, in order to prompt the user to design the object generic features. Each animation figure further comprises hinges that will enable the user to control its limb moving. All actions, selected from the Actions Applied tray or from a right click menu, can be dragged and dropped and inserted into a Control Time Table. The timing of all actions, inserted into the Control Time Table, will start on the time table point of insertion and will be programmed to last according to length arrows extended by the user on the Control Time Table. Double click on any action, appearing on the abovementioned Control Time Table, will open an action edit window which is used to edit the action (e.g. sound recording, move details). The animation wizard enables the user to start an online editing mode by pressing the Play Clip button, thus, enables the user to edit the scene while playing it on SCENE 1 portion. Therefore, the online recording and editing while supplying editing commands, enables the user to avoid offline editing and re-compilation of the movie to see the results.

According to a preferred embodiment of the invention, the animation objects or movies may include web banners (advertising images or sequences of images) which are files, such as Small Web Format (SWF—a partially open repository for multimedia that contain interactive animations) files.

Although embodiments of the present invention have been described by way of illustration, it will be understood that the invention may be carried out with many variations, modifications, and adaptations, without departing from its spirit or exceeding the scope of the claims.

1. An animation generation system for online recording and editing of elaborated animation objects and movies, comprising:
a) a plurality of elaborated animated objects, each of which including:
a.1) hinges for controlling the object's limb movement;
a.2) an accumulated collection of associated actions having parameters which can be programmed by authorized animation developers;
a.3) an accumulated collection of associated actions of associated generic features;
a.4) an accumulated collection of associated actions complex moves comprising ready made small actions;
b) a database of elaborated animated objects and movies containing accumulated collection of animation movies and objects created by said developers;
c) a user interface module for:
c.1) presenting objects' features;
c.2) allowing a user to choose animation objects, animation scenes backgrounds or related actions;
c.3) inserting actions with their programmed time table, by dragging and dropping;
c.4) playing an edited scene; and
c.5) recognizing the action pattern of a developer's input and identifying the animation object and suggesting a variety of possible actions.

2. The animation generation system of claim 1, wherein the user interface module comprises:
a.1) an Objects tray, a Scene Background tray and an Actions Applied tray being capable of prompting a user to choose one of said animation objects, animation scenes backgrounds or related actions, applied for composing his own animation movie;
a.2) a side table, on which every object features will be presented upon its selection, for prompting the developers to design the object generic features;
a.3) a Control Time Table to which all actions, selected from the Actions Applied tray or from a right click menu, can be inserted by dragging and dropping, such that the timing of all inserted actions will start on the time table point of insertion and will be programmed to last according to the length of arrows extended by said developers using an editing window;
a.4) a Play Clip button for enabling said developers to start an online editing mode for editing the scene while playing it on a related portion of the user interface, without needing re-compilation;
a.5) a User Action Pattern recognition application, linked to said database and with said user interface unit, for receiving the developer's input and recognizing the action pattern;
a.6) an Object processor which receives the recognized action pattern, identifies the animation object and suggests a variety of possible actions through said User interface unit.

3. The animation generation system of claim 1, wherein the user's action sequence user's object's inherited pre-programmed properties and action parameters are monitored, for automatically suggesting the user a variety of relevant pre-defined properties and action parameters.

4. The animation generation system of claim 1, wherein the animation object further comprises associated objects and object actions.

5. The animation generation system of claim 1, wherein a Double click on any action appearing on the Control Time Table opens an action edit window for editing said action.

6. The animation generation system of claim 1, wherein the authorized animation developers comprises registered web site members.

7. The animation generation system of claim 1, wherein authorized animation developers may communicate through messages which comprise the created animation movies and objects using the Internet infrastructure.

8. The animation generation system of claim 1, wherein the newly created animation movies and objects are based on the existing animation movies and objects.

9. The animation generation system of claim 1, wherein the authorized animation developers set the life span of the newly created animation movies and objects.

10. The animation generation system of claim 1, wherein the Control Time Table provides a single synchronized set of axes which incorporates different objects into the clip design environment.

11. The animation generation system of claim 1, wherein the newly created animation movies and objects further comprise a commercial logo of a company.

12. The animation generation system of claim 10, wherein clicking on the newly created animation movies and objects, after stopping or during clip playing, enables the group of animation users to stop the animation movie and to be linked to a designated Web site, linked with the specific scene, specific screen area and specific timing of animation movies and objects.

13. The animation generation system of claim 1, wherein the animation objects or movies include banner ads.

14. The animation generation system of claim 13, wherein the banner ads are files in SWF format.

15. An animation generation method for online recording and editing of elaborated animation objects and movies, comprising:
storing a database of elaborated animated objects and movies containing ever growing data representing collection of animation movies and objects created by a group of authorized animation developers,
wherein said elaborated animated objects comprise:
hinges that enable said animation developers to control the objects limb moving,
ever growing data representing a collection of associated actions having parameters which can be programmed by said authorized animation developers, a collection of associated complex moves comprising ready made small actions or a collection of associated generic features;
picking an inherited animation object from the object tray, wherein every inherited animation object has inherited features and action attributes;
picking, from Scene Backgrounds tray and Action Applied tray, the inherited animation objects respective inherited features and action attributes;
analyzing the selected objects, along with their associated objects and its associated capabilities;
detecting the action sequence made by the authorized animation developers;
suggesting a set possible actions/parameters, to the authorized group of animation developers, according to the previously detected action sequence and the respective animation objects they were made on;
allowing the authorized animation developers to selects their preferred parameters;
providing the ability of editing the scene during “play” mode which avoid the need of offline editing and re-compilation of the movie to see the results;
scheduling all action related parameters by inserting them into the movie timeline ruler; wherein all action related parameters will start according to the timeline ruler point of insertion and will last in accordance to the schedule defined by the timeline ruler; and
populating all action related parameters into a movie design files including a movie timeline ruler.
